(19) United States
(12) Patent Application Publication
(10) Pub. No.: US 2026/0056027 A1
(43) Pub. Date: Feb. 26, 2026

(54) VEHICLE MANAGEMENT SYSTEM

(71) Applicant: TOYOTA JIDOSHA KABUSHIKI KAISHA, Toyota-shi (JP)

(72) Inventor: Hiroki FURUTA, Susono-shi (JP)

(73) Assignee: TOYOTA JIDOSHA KABUSHIKI KAISHA, Toyota-shi (JP)

(21) Appl. No.: 19/221,013

(22) Filed: May 28, 2025

(30) Foreign Application Priority Data
Aug. 21, 2024 (JP) 2024-139740

(51) Int. Cl. G01C 21/00; B60G 17/018

(52) U.S. Cl. CPC G01C 21/3807; B60G 17/018

(57) ABSTRACT

The vehicle management system maintains a map indicating a correspondence relationship between a vertical motion parameter and a position associated with the vertical motion of the wheels of the vehicle. In addition, the vehicle management system gives a privilege to the user of the target vehicle. The route to the destination of the target vehicle includes a first route and a second route having a lower degree of enrichment of the map than the first route. The vehicle management system sets a privilege when the target vehicle travels on the second route to be larger than a privilege when the target vehicle travels on the first route. When the target vehicle travels on the second route, the vehicle management system causes the target vehicle to collect information for updating the map along the second route.

### CROSS-REFERENCE TO RELATED APPLICATION

This application claims priority to Japanese Patent Application No. 2024-139740 filed on Aug. 21, 2024. The disclosure of the above-identified application, including the specification, drawings, and claims, is incorporated by reference herein in its entirety.

### BACKGROUND

### 1. Technical Field

The present disclosure relates to the use of a map indicating a correspondence relationship between a position and a parameter associated with vertical motion of a wheel of a vehicle.

### 2. Description of Related Art

US 2018/0154723 A1 discloses a road surface displacement map indicating a correspondence relationship between road surface displacement (road surface unevenness) and a position. Vibration suppression control is performed by using such a road surface displacement map. Specifically, road surface displacement at a predetermined position ahead of a vehicle is recognized in advance from the road surface displacement map. The control amount of active suspensions is calculated in advance according to the road surface displacement recognized in advance. Vibration of the vehicle is effectively suppressed by controlling the active suspensions at the timing when wheels pass through the predetermined position.

### SUMMARY

A map indicating a correspondence relationship between a position and a parameter associated with vertical motion of a wheel of a vehicle is considered. Such a map may be used for vehicle control such as vibration suppression control. However, the vehicle control cannot be performed using the map in an area where the map has not yet been generated.

The present disclosure can provide a technique capable of promoting improvement in the degree of fullness of a map indicating a correspondence relationship between a position and a parameter associated with vertical motion of a wheel of a vehicle.

An aspect of the present disclosure relates to a vehicle management system. The vehicle management system includes: one or more storage devices, the storage devices being configured to store a map indicating a correspondence relationship between a position and a vertical motion parameter associated with vertical motion of a wheel of a vehicle; and one or more processors, the processors being configured to give a privilege to a user of a target vehicle. A route to a destination of the target vehicle includes a first route and a second route having a degree of fullness of the map that is lower than the first route. The one or more processors are configured to set the privilege to be given when the target vehicle travels through the second route to be greater than the privilege to be given when the target vehicle travels through the first route, and cause the target vehicle to collect information for updating the map along the second route when the target vehicle travels through the second route.

According to the present disclosure, when the target vehicle travels through the second route having a lower degree of fullness of the map, more privileges are given to the user of the target vehicle. In other words, the user of the target vehicle is given an incentive to select the second route having a lower degree of fullness of the map. Consequently, it is expected that there are increased opportunities for the target vehicle to travel through the second route having a lower degree of fullness of the map. When the target vehicle travels through the second route, information for updating the map along the second route is newly obtained. As a result, the degree of fullness of the map along the second route is improved. In this manner, according to the present disclosure, it is possible to promote improvement in the degree of fullness of the map.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a configuration example of a vehicle according to an embodiment;

FIG. 2 is a conceptual diagram illustrating a configuration example of a suspension according to the embodiment;

FIG. 3 is a flowchart illustrating an example of an unsprung displacement calculation process according to the embodiment;

FIG. 4 is a block diagram illustrating a configuration example of the vehicle control system according to the embodiment;

FIG. 5 is a block diagram illustrating an example of driving environment information according to the embodiment;

FIG. 6 is a block diagram illustrating a configuration example of the map management system according to the embodiment;

FIG. 7 is a conceptual diagram for explaining an unsprung displacement map according to the embodiment;

FIG. 8 is a flowchart schematically illustrating a map generation/update process according to the embodiment;

FIG. 9 is a conceptual diagram for explaining preview control using an unsprung displacement map according to the embodiment;

FIG. 10 is a flowchart illustrating preview control using an unsprung displacement map according to the embodiment;

FIG. 11 is a conceptual diagram for explaining the map fullness of the unsprung displacement map according to the embodiment;

FIG. 12 is a conceptual diagram for explaining an outline of the vehicle management system according to the embodiment;

FIG. 13 is a block diagram for describing a configuration example of the vehicle management system according to the embodiment;

FIG. 14 is a conceptual diagram for describing a user presentation function of the vehicle management system according to the embodiment;

FIG. 15 is a conceptual diagram for describing a route determination function of the vehicle management system according to the embodiment; and

FIG. 16 is a conceptual diagram for explaining a mode switching function of the vehicle management system according to the embodiment.

### DETAILED DESCRIPTION OF EMBODIMENTS

Embodiments of the present disclosure will be described with reference to the accompanying drawings.

### 1. Suspension and Vertical Motion Parameters

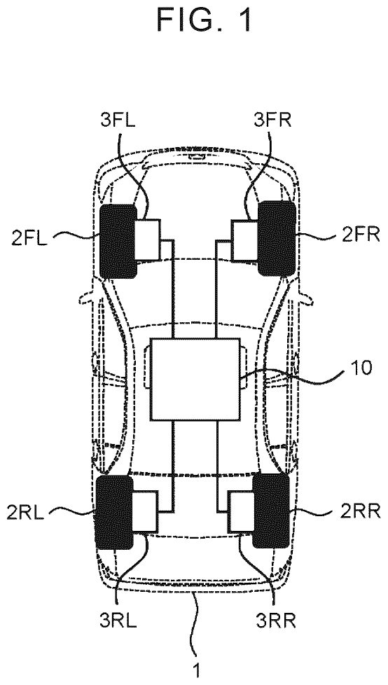

FIG. 1 is a schematic diagram illustrating a configuration example of a vehicle 1 according to the present embodiment. The vehicle 1 includes wheels 2 and a suspension 3. The wheel 2 includes a left front wheel 2FL, a right front wheel 2FR, a left rear wheel 2RL, and a right rear wheel 2RR. Suspension 3FL, 3FR, 3RL and 3RR are provided for each of the left front wheel 2FL, the right front wheel 2FR, the left rear wheel 2RL, and the right rear wheel 2RR. In the following description, each wheel is referred to as a wheel 2, and each suspension is referred to as a suspension 3, particularly when there is no need for distinction.

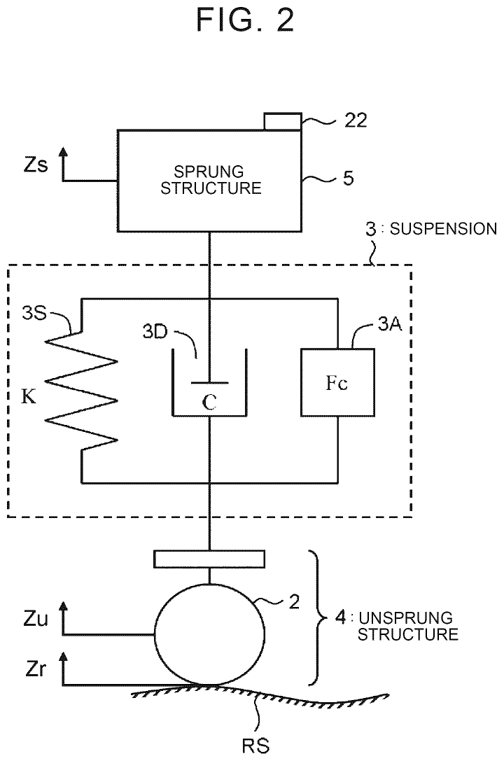

FIG. 2 is a conceptual diagram illustrating a configuration example of the suspension 3. The suspension 3 is provided to connect between the unsprung structure 4 and the sprung structure 5 of the vehicle 1. The unsprung structure 4 includes wheels 2. The suspension 3 includes a spring 3S, a damper (shock absorber) 3D, and an actuator 3A. The spring 3S, the damper 3D, and the actuator 3A are provided in parallel between the unsprung structure 4 and the sprung structure 5. The spring rate of the spring 3S is K. The damping factor of the damper 3D is C. The damping force of the damper 3D may be variable. The actuator 3A applies a vertical control force Fc between the unsprung structure 4 and the sprung structure 5.

Here, the term is defined. The “road surface displacement Zr” is a vertical displacement of the road surface RS. The “unsprung displacement Zu” is the vertical displacement of the unsprung structure 4. The “sprung displacement Zs” is a vertical displacement of the sprung structure 5. The “unsprung speed Zu′” is the vertical speed of the unsprung structure 4. The “sprung speed Zs” is the vertical speed of the sprung structure 5. The “unsprung acceleration Zu” is the vertical acceleration of the unsprung structure 4. The “sprung acceleration Zs” is the vertical acceleration of the sprung structure 5. Note that the sign of each parameter is positive in the case of the upward direction and negative in the case of the downward direction.

The wheels 2 move on the road surface RS. In the following explanation, a parameter related to the vertical motion of the wheel 2 is referred to as a “vertical motion parameter”. Examples of the vertical motion parameter include the road surface displacement Zr, the unsprung displacement Zu, the unsprung velocity Zu′, the unsprung acceleration Zu, the sprung displacement Zs, the sprung velocity Zs′, and the sprung acceleration Zs. The up-down motion parameter may also be referred to as a “road surface displacement related parameter” associated with the road surface displacement Zr.

For example, in the following explanation, a case where the vertical motion parameter is the unsprung displacement Zu will be considered. In the case of generalization, “unsprung displacement” in the following description is read as “vertical motion parameter”.

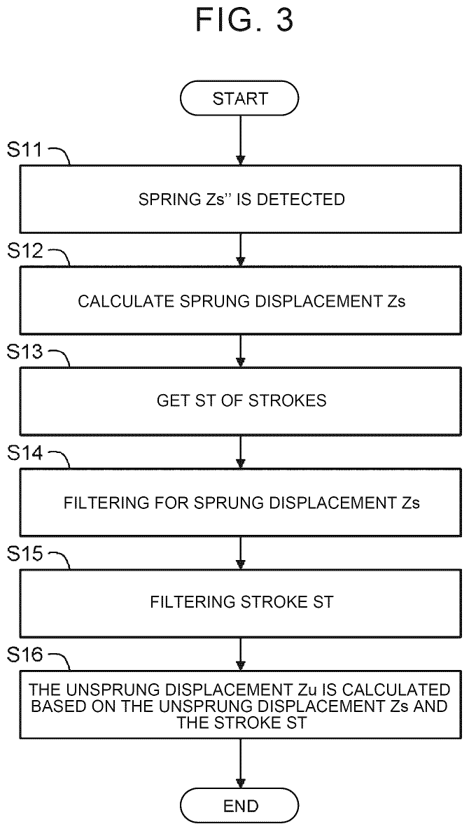

FIG. 3 is a flowchart illustrating an example of unsprung displacement calculation processing.

In S11, the sprung acceleration Zs is detected by the sprung acceleration sensor 22 installed in the sprung structure 5. In S12, the sprung displacement Zs is calculated by integrating the sprung acceleration Zs on the second floor.

In S13, a stroke ST (=Zs−Zu) is obtained, which is the relative displacement between the sprung structure 5 and the unsprung structure 4. For example, the stroke ST is detected by a stroke sensor installed in the suspension 3. As another example, the stroke ST may be estimated based on the sprung acceleration Zs by an observer configured based on a single-wheel two-degree-of-freedom model.

In S14, the time-series data of the sprung displacement Zs is filtered in order to suppress the effect of the sensor drift or the like. Similarly, in S15, the time-series data of the stroke ST is filtered. For example, the filter is a band-pass filter that passes signal components in a specific frequency band. The specific frequency band may be set to include the sprung resonance frequency of the vehicle 1. For example, the specified frequency band is 0.3 to 10 Hz.

In S16, the difference between the sprung displacement Zs and the stroke ST is calculated as the sprung displacement Zu.

Instead of S14 and S15, the time-series data of the unsprung displacement Zu calculated in S16 may be filtered.

As yet another example, the unsprung acceleration Zu may be detected by the unsprung acceleration sensor, and the unsprung displacement Zu may be calculated from the unsprung acceleration Zu.

### 2. Advanced Vehicle Control System

### 2-1. Configuration Example

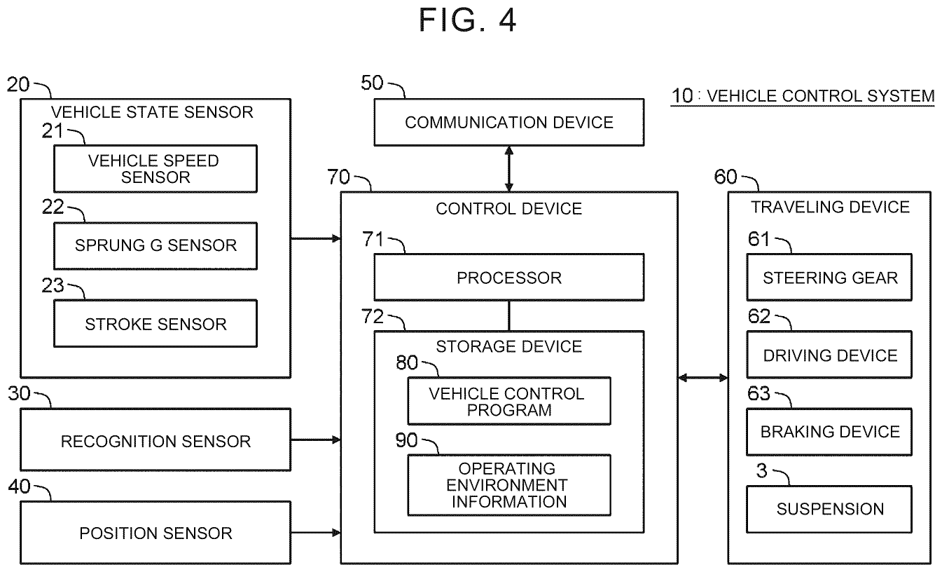

FIG. 4 is a block diagram illustrating a configuration example of the vehicle control system 10 according to the present embodiment. The vehicle control system 10 is applied to the vehicle 1 and controls the vehicle 1. For example, the vehicle control system 10 is mounted on the vehicle 1. As another example, the vehicle control system 10 may be distributed between the vehicle 1 and a remote device. The vehicle control system 10 includes a vehicle state sensor 20, a recognition sensor 30, a position sensor 40, a communication device 50, a traveling device 60, and a control device 70.

The vehicle state sensor 20 is mounted on the vehicle 1 and detects a state of the vehicle 1. The vehicle state sensor 20 includes a vehicle speed sensor (wheel speed sensor) 21 for detecting the vehicle speed V of the vehicle 1, a sprung acceleration sensor 22 for detecting the sprung acceleration Zs”, and the like. The vehicle-state sensor 20 may include a stroke sensor 23 that detects a stroke ST. The vehicle state sensor 20 may include an unsprung acceleration sensor. In addition, the vehicle state sensor 20 includes a lateral acceleration sensor, a yaw rate sensor, a steering angle sensor, and the like.

The recognition sensor 30 is mounted on the vehicle 1 and recognizes (detects) a situation around the vehicle 1. Examples of recognition sensors include cameras, LIDAR (Laser Imaging Detection and Ranging), radars, and the like.

The position sensor 40 is mounted on the vehicle 1 and includes a positioning device that detects the position and the azimuth of the vehicle 1. For example, the position sensor 40 includes a GNSS (Global Navigation Satellite System). For example, the position sensor 40 includes an RTK-GNSS.

The communication device 50 communicates with the outside of the vehicle 1.

The traveling device 60 includes a steering device 61, a driving device 62, a braking device 63, and a suspension 3 (see FIG. 2) mounted on the vehicle 1. The steering device 61 steers the wheels 2. For example, the steering device 61 includes a power steering (EPS: Electric Power Steering) device. The driving device 62 is a power source that generates driving force. Examples of the driving device 62 include an engine, an electric motor, and an in-wheel motor. The braking device 63 generates a braking force.

The control device 70 is a computer that controls the vehicle 1. The control device 70 may be mounted on the vehicle 1 or may be partially included in the remote device. The control device 70 includes one or more processors 71 (hereinafter simply referred to as processors 71) and one or more storage devices 72 (hereinafter simply referred to as storage devices 72). The processor 71 executes various processes. Examples of the processor 71 include CPU (Central Processing Unit), ASIC (Application Specific Integrated Circuit), FPGA (Field-Programmable Gate Array), and the like. The processor 71 may also be referred to as processing circuitry. The storage device 72 stores various kinds of information necessary for processing by the processor 71. Examples of the storage device 72 include volatile memory, non-volatile memory, HDD (Hard Disk Drive), SSD (Solid State Drive), and the like. The control device 70 may include one or more ECU (Electronic Control Unit).

The vehicle control program 80 is a computer program for controlling the vehicle 1, and is executed by the processor 71. The vehicle control program 80 is stored in the storage device 72. Alternatively, the vehicle control program 80 may be recorded in a computer-readable recording medium. When the processor 71 executes the vehicle control program 80, the function of the control device 70 is realized.

### 2-2. Operating Environment Information

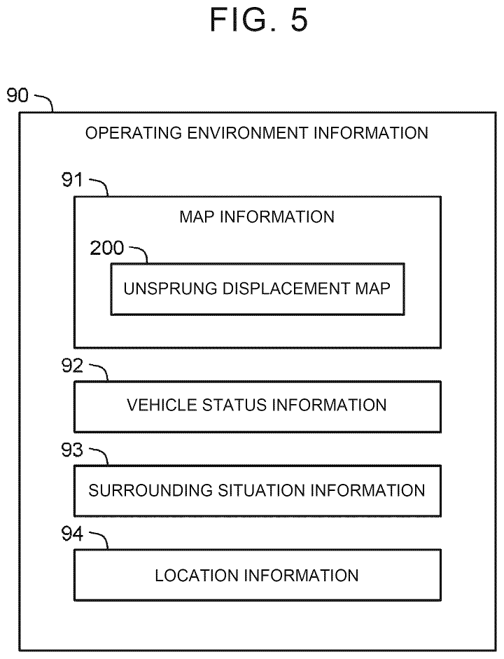

FIG. 5 is a block diagram illustrating an example of driving environment information 90 indicating a driving environment of the vehicle 1. The driving environment information 90 is stored in the storage device 72. The driving environment information 90 includes map information 91, vehicle state information 92, surrounding situation information 93, and position information 94.

The map information 91 includes a general navigation map. The map information 91 may indicate a lane arrangement, a road shape, and the like. The map information 91 may include position information such as a white line, a traffic light, a sign, and a landmark. The map information 91 is obtained from a map database. The map database may be mounted on the vehicle 1 or may be stored in an external management server. In the latter case, the control device 70 communicates with the management server and acquires necessary map information 91.

The map information 91 further includes an “unsprung displacement map 200”. Details of the unsprung displacement map 200 will be described later.

The vehicle state information 92 is information indicating the state of the vehicle 1. The control device 70 acquires the vehicle state information 92 from the vehicle state sensor 20. For example, the vehicle state information 92 includes a vehicle speed V, a sprung acceleration Zs, a stroke ST, a lateral acceleration, a yaw rate, a steering angle, and the like. The vehicle speed V may be calculated from the vehicle position detected by the position sensor 40. The control device 70 may calculate the unsprung displacement Zu by the method illustrated in FIG. 3. The vehicle state information 92 then also includes the unsprung displacement Zu calculated by the control device 70.

The surrounding situation information 93 is information indicating a situation around the vehicle 1. The control device 70 recognizes a situation around the vehicle 1 using the recognition sensor 30, and acquires the surrounding situation information 93. For example, the surrounding situation information 93 includes image information captured by the camera. Alternatively, the surrounding situation information 93 includes point cloud information obtained by LIDAR.

The surrounding situation information 93 further includes “object information” regarding an object around the vehicle 1. Examples of the object include a pedestrian, a bicycle, another vehicle (a preceding vehicle, a parked vehicle, and the like), a road configuration (a white line, a curb, a guardrail, a wall, a central separation band, a roadside structure, and the like), a sign, a pole, an obstacle, and the like. The object information indicates a relative position and a relative speed of the object with respect to the vehicle 1. For example, by analyzing image information obtained by a camera, an object can be identified and a relative position of the object can be calculated. It is also possible to identify an object based on the point cloud data obtained by LIDAR, and to acquire the relative position and the relative velocity of the object.

The position information 94 is information indicating the position and the azimuth of the vehicle 1. The position includes a horizontal position and a vertical position. For example, the horizontal position is defined by latitude and longitude. The vertical position is defined by altitude. Examples of the altitude include sea level, geoid height, ellipsoidal height, and the like. The control device 70 acquires the position information 94 based on the measurement by the position sensor 40 such as a GNSS. As another example, the control device 70 may acquire the position information 94 by dead reckoning. As yet another example, the control device 70 may acquire the highly accurate position information 94 by a well-known Localization using the object information and the map information 91.

### 2-3. Vehicle Control

The control device 70 executes vehicle travel control for controlling travel of the vehicle 1. The vehicle travel control includes steering control, drive control, and braking control. The control device 70 executes vehicle travel control by controlling the traveling device 60 (the steering device 61, the driving device 62, and the braking device 63). The control device 70 may perform driving support control for supporting driving of the vehicle 1 based on the driving environment information 90. Examples of the driving assistance control include lane keeping control, collision avoidance control, and automatic driving control.

Furthermore, the control device 70 controls the suspension 3. Typically, the control device 70 controls the suspension 3 to perform vibration damping control for suppressing vibration of the sprung structure 5 of the vehicle 1 (target vehicle). For example, the control device 70 controls the actuator 3A to generate a vertical control force Fc between the unsprung structure 4 and the sprung structure 5 (see FIG. 2), thereby suppressing vibrations of the sprung structure 5. Alternatively, the control device 70 may variably control the damping force of the damper 3D. The vibration damping control includes “preview control” described later.

### 3. Map Management System

### 3-1. Configuration Example

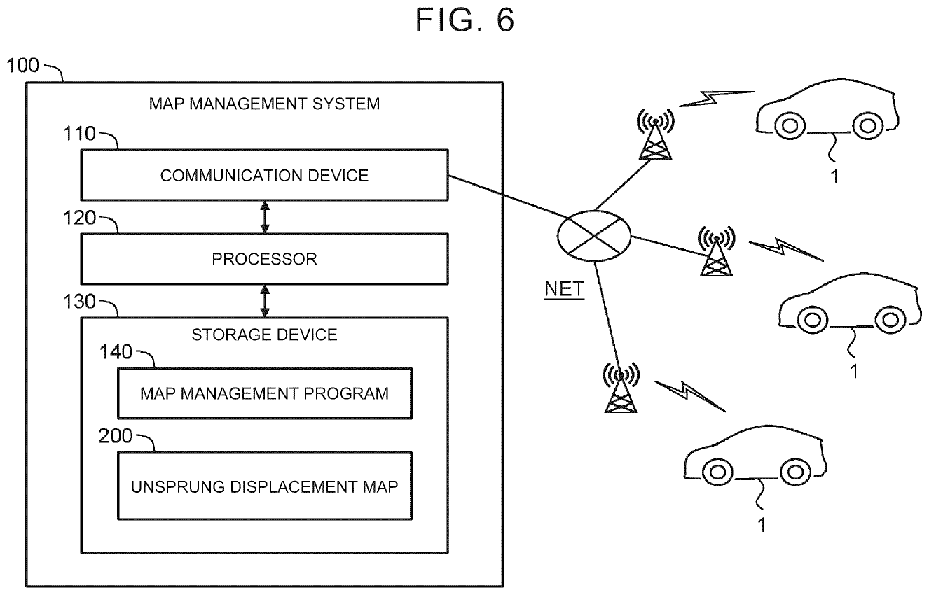

FIG. 6 is a block diagram illustrating a configuration example of the map management system 100 according to the present embodiment. The map management system 100 is a computer that manages various types of map information. The management of the map information includes generation, update, provision, distribution, and the like of the map information. Typically, the map management system 100 is a management server on the cloud. The map management system 100 may be a distributed system in which a plurality of servers performs distributed processing.

The map management system 100 includes a communication device 110. The communication device 110 is connected to a communication networking NET. For example, the communication device 110 communicates with a large number of vehicles 1 via a communication networking NET.

The map management system 100 further includes one or more processors 120 (hereinafter simply referred to as processors 120) and one or more storage devices 130 (hereinafter simply referred to as storage devices 130). The processor 120 executes various types of information processing. Examples of the processor 120 include CPU, ASIC, FPGA, and the like. The processor 120 may also be referred to as processing circuitry. The storage device 130 stores various types of map information. The storage device 130 stores various kinds of information necessary for processing by the processor 120. Examples of the storage device 130 include a volatile memory, a nonvolatile memory, and an HDD, SSD.

The map management program 140 is a computer program for map management, and is executed by the processor 120. The map management program 140 is stored in the storage device 130. Alternatively, the map management program 140 may be recorded in a computer-readable recording medium. When the processor 120 executes the map management program 140, the functions of the map management system 100 are realized.

The processor 120 communicates with the vehicle control system 10 of the vehicle 1 via the communication device 110. The processor 120 collects various types of information from the vehicle control system 10, and generates and updates map information based on the collected information. Further, the processor 120 distributes the map information to the vehicle control system 10. The processor 120 also provides map information in response to a request from the vehicle control system 10.

### 3-2. Unsprung Displacement Map

One of the map information managed by the map management system 100 is “unsprung displacement map (vertical motion parameter map) 200”. The unsprung displacement map 200 is a map relating to the unsprung displacement Zu (vertical motion parameter), and indicates a correspondence between the unsprung displacement Zu (vertical motion parameter) and the position. The unsprung displacement map 200 is stored in the storage device 130.

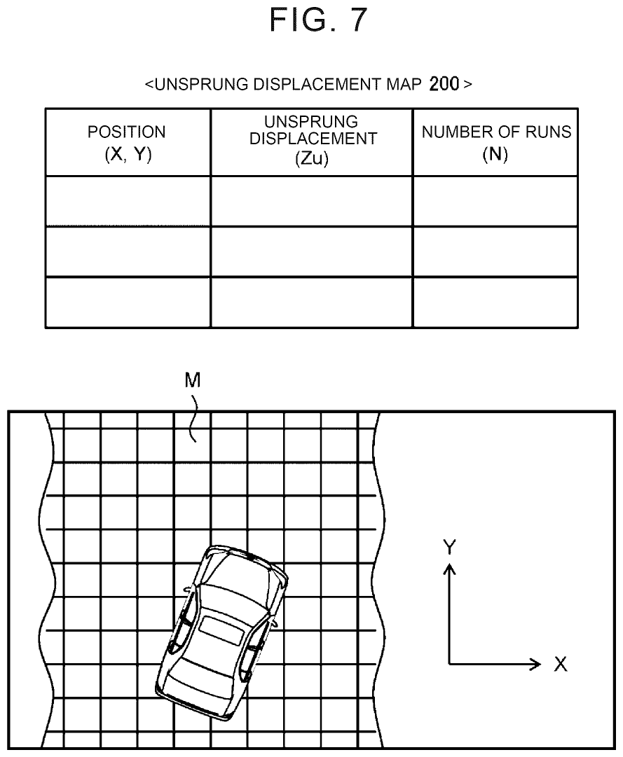

FIG. 7 is a conceptual diagram for explaining the unsprung displacement map 200. XY plane represents a horizontal plane. For example, an absolute coordinate system in a horizontal plane is defined by a latitude direction and a longitude direction, and a horizontal position is defined by a latitude and a longitude. The unsprung displacement map 200 represents a correspondence between at least X, Y and the unsprung displacement Zu. In other words, the unsprung displacement map 200 represents the unsprung displacement Zu as a function of at least X, Y.

The road area may be partitioned into meshes on a horizontal plane. That is, the road area may be divided into a plurality of unit areas M on the horizontal plane. The unit area M is, for example, a square. The length of one side of the square is, for example, 10 cm. The unsprung displacement map 200 represents a correspondence between the position of the unit area M and the unsprung displacement Zu. The position of the unit area M may be defined by a representative position (e.g., center position) of the unit area M, or may be defined by a range (latitude range, longitude range) of the unit area M. The unsprung displacement Zu of the unit area M is, for example, the mean of the unsprung displacement Zu acquired in the unit area M. As the unit area M decreases, the resolution of the unsprung displacement map 200 increases.

As a modification, a different unsprung displacement map 200 may be prepared for each vehicle speed range. For example, each of the low-speed, medium-speed, and high-speed unsprung displacement maps 200 may be provided.

### 3-3. Map Generation/Update Processing

The processor 120 collects information from a large number of vehicles 1 via the communication device 110. Then, the processor 120 generates and updates the unsprung displacement map 200 based on the information collected from the plurality of vehicles 1. Hereinafter, an example of the map generation/update process will be described in more detail.

The position in the unsprung displacement map 200 is a position where the wheel 2 has passed. The position of each wheel 2 is calculated based on the position information 94. Specifically, the relative positional relationship between the reference point of the vehicle position in the vehicle 1 and each wheel 2 is known information. The position of each wheel 2 can be calculated based on the relative positional relationship and the vehicle position indicated by the position information 94.

The unsprung displacement Zu is calculated by the method shown in FIG. 3. That is, by using the vehicle state sensor 20 mounted on the vehicle 1, the sprung displacement Zs and the stroke ST can be obtained. These sprung displacement Zs and stroke ST are referred to as “sensor-based information” for convenience. The unsprung displacement Zu is calculated based on the sensor-based information.

For example, during traveling of the vehicle 1, the control device 70 of the vehicle control system 10 calculates the unsprung displacement Zu in real time based on the sensor-based information. The control device 70 also associates the same-timed wheel position with the unsprung displacement Zu. Then, the control device 70 transmits a set of time-series data of the wheel position and time-series data of the unsprung displacement Zu to the map management system 100. The processor 120 of the map management system 100 generates and updates the unsprung displacement map 200 based on the time series data of the wheel position and the time series data of the unsprung displacement Zu.

As another example, the control device 70 of the vehicle control system 10 associates wheel positions of the same timing with sensor-based information. Then, the control device 70 transmits a set of time-series data of the wheel position and time-series data of the sensor base information to the map management system 100. The processor 120 of the map management system 100 calculates the unsprung displacement Zu based on the received sensor-based data. Further, the processor 120 generates and updates the unsprung displacement map 200 based on the time series data of the wheel position and the time series data of the unsprung displacement Zu.

Note that when the unsprung displacement Zu is calculated in the map management system 100, since there is no restriction on the processing duration, the filtering processing can be performed using the zero-phase filter. By using a zero phase filter, “phase shift” can be suppressed.

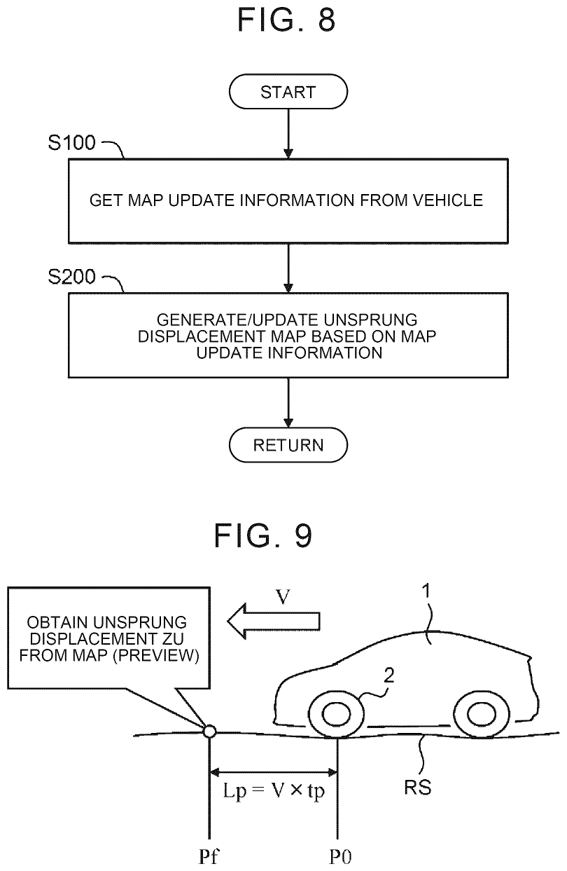

FIG. 8 is a flowchart schematically illustrating a map generation/update process according to the present embodiment.

In S100, the processor 120 of the map management system 100 acquires “map updating information” from the vehicle 1 (the vehicle control system 10) via the communication device 110. The map update information includes time-series data of the position (wheel position) of the vehicle 1. The map updating information includes time-series data of sensor-based information (e.g., sprung displacement Zs, stroke ST) required for calculating the unsprung displacement Zu. Alternatively, the information for updating the map may include time-series data of the unsprung displacement Zu calculated by the control device 70 of the vehicle control system 10.

In S200, the processor 120 of the map management system 100 generates/updates the unsprung displacement map 200 based on the map updating data.

For example, map update information obtained in the past is stored in the storage device 130. The processor 120 updates the unsprung displacement map 200 based on the latest (current) map update information and the past map update information for the same position. For example, the unsprung displacement Zu at a certain position (unit area M) is a mean of the unsprung displacement Zu calculated from the N times of map update information including the latest map update information. Here, N is an integer of 1 or more. N may also be referred to as “number of runs,” “data parameter,” etc. As the number of travels N is increased, the accuracy of the unsprung displacement Zu calculated from the information for updating the map N times is also increased. As illustrated in FIG. 7, the unsprung displacement map 200 may indicate a correspondence between the “position (unit area M)”, the “number of travels N”, and the “unsprung displacement Zu”.

### 3-4. Modification

Vehicle control system 10 of vehicle 1 may hold a database of unsprung displacement maps 200 and generate/update its unsprung displacement maps 200. That is, the map management system 100 may be included in the vehicle control system 10.

### 4. Preview Control Using Unsprung Displacement Map

The control device 70 of the vehicle control system 10 communicates with the map management system 100 via the communication device 50. The control device 70 acquires the unsprung displacement map 200 of the area including the current position of the vehicle 1 from the map management system 100. The unsprung displacement map 200 is stored in the storage device 72. Then, the control device 70 executes “preview control”, which is a kind of damping control, based on the unsprung displacement map 200.

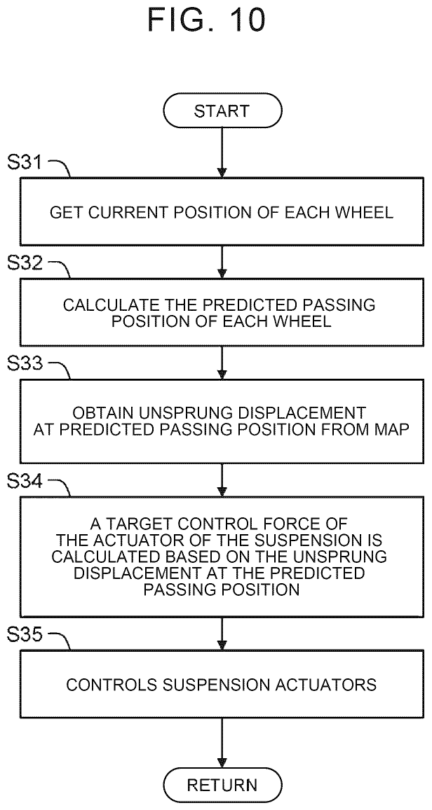

FIG. 9 is a conceptual diagram for explaining preview control. FIG. 10 is a flowchart illustrating preview control. The preview control will be described with reference to FIGS. 9 and 10.

In S31, the control device 70 acquires the present position P0 of the respective wheels 2. The relative positional relationship between the reference point of the vehicle position in the vehicle 1 and each wheel 2 is known information. The position of each wheel 2 can be calculated based on the relative positional relationship and the vehicle position indicated by the position information 94.

In S32, the control device 70 calculates the predicted passing position Pf of the wheel 2 after the preview-time tp. The preview time tp is set to be equal to or longer than a time required for a computation process or a communication process required for operating the actuator 3A of the suspension 3, for example. The preview-time tp may be fixed or may be variable depending on the circumstances. The preview distance Lp is given by the product of the preview time tp and the vehicle speed V. The predicted passing position Pf is a position forward by the preview-distance Lp from the present position P0. As a modification, the control device 70 may calculate the predicted traveling route based on the vehicle speed V and the steering angle of the wheel 2, and may calculate the predicted passing position Pf based on the predicted traveling route.

In S33, the control device 70 reads out the unsprung displacement Zu in the predicted passing position Pf from the unsprung displacement map 200.

In S34, the control device 70 calculates the target control force Fc_t of the actuator 3A of the suspension 3 based on the unsprung displacement Zu in the predicted passing position Pf. The target control force Fc_t is calculated as follows, for example.

The equation of motion for the sprung structure 5 (see FIG. 2) is represented by the following equation (1):

$$Mathematical formula 1$$

$$m \cdot {Zs}^{″} = C ( {Zu}^{′} - {Zs}^{′} ) + K ( Zu + Zs ) - Fc \qquad ( 1 )$$

In Equation (1), m is the mass of the sprung structure 5, C is the damping factor of the damper 3D, K is the spring constant of the spring 3S, and Fc is the vertical control force Fc generated by the actuator 3A. If the control force Fc completely cancels the oscillation of the sprung structure 5 (Zs″=0, Zs′=0, Zs=0), the control force Fc is expressed by the following equation (2).

$$Mathematical formula 2$$

$$Fc = C \cdot {Zu}^{′} + K \cdot Zu \qquad ( 2 )$$

The control force Fc providing at least the damping effect is expressed by the following equation (3).

$$Mathematical formula 3$$

$$Fc = α \cdot C \cdot {Zu}^{′} + β \cdot K \cdot Zu \qquad ( 3 )$$

In Equation (3), the gain α is greater than 0 and less than or equal to 1, and the gain β is also greater than 0 and less than or equal to 1. When the differential term in Equation (3) is omitted, the control force Fc that provides at least the damping effect is expressed by the following Equation (4).

$$Mathematical formula 4$$

$$Fc = β \cdot K \cdot Zu \qquad ( 4 )$$

The control device 70 calculates the target control force Fc_t according to Equation (3) or Equation (4). That is, the control device 70 calculates the target control force Fc_t by substituting the unsprung displacement Zu in the predicted passing position Pf into the equation (3) or the equation (4).

In S35, the control device 70 controls the actuator 3A so as to generate the target control force Fc_t at a timing at which the wheel 2 passes through the predicted passing position Pf. The timings at which the wheels 2 pass through the predicted passing position Pf are known from the preview-time tp.

By the preview control using the unsprung displacement map 200 described above, the vibration of the vehicle 1 (the sprung structure 5) can be effectively suppressed.

### 5. Map Quality and Improvement

### 5-1. Map Fullness

As described in Section 3 above, the unsprung displacement map 200 is generated and updated based on map update information collected from a large number of vehicles 1. In a position where the map updating data is not yet obtained, the map data (unsprung displacement Zu) of the unsprung displacement map 200 does not exist. In a position where the map data does not exist, vehicle control such as preview control using the map data cannot be performed. In addition, although the map data is present, there is a possibility that the accuracy of the map data is low at a position where the number of travels N is small. At a position where the accuracy of the map data is low, the accuracy of vehicle control such as preview control using the map data may also be low.

Therefore, it is useful to grasp how much the unsprung displacement map 200 is enriched from the viewpoint of vehicle control using the unsprung displacement map 200. The degree that indicates how much the unsprung displacement map 200 is full is hereinafter referred to as “map fullness”. The map fullness may also be referred to as “coverage” of the unsprung displacement map 200. The map fullness may also be referred to as “map data amount” of the unsprung displacement map 200.

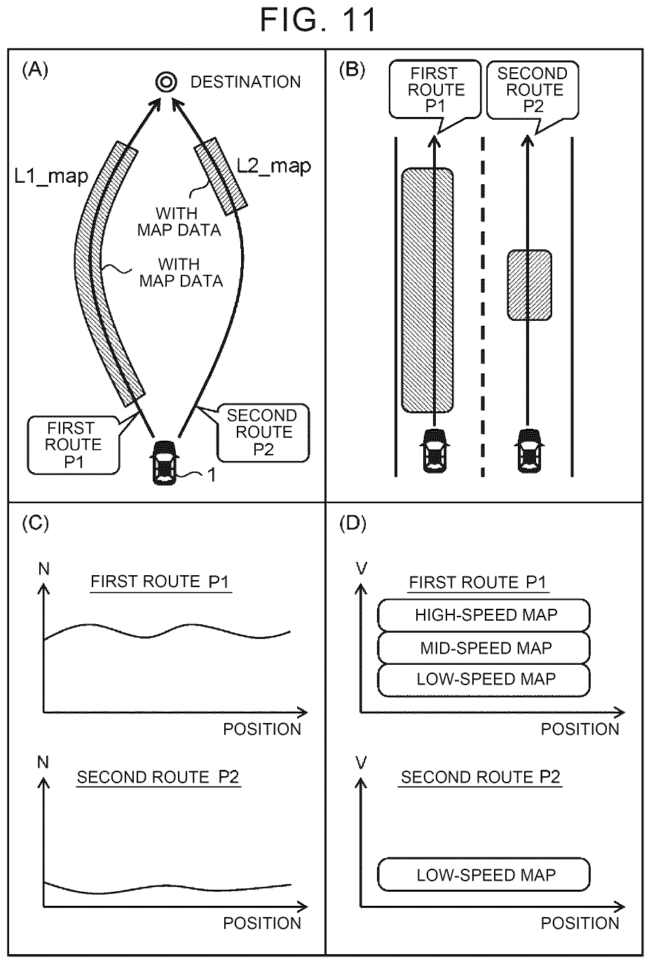

FIG. 11 is a conceptual diagram for explaining the map fullness of the unsprung displacement map 200. Here, in particular, the map fullness of the route on which the vehicle 1 travels will be described. For simplicity, consider two types of routes from the present position of the vehicle 1 to the destination: the first route P1 and the second route P2. The same applies to three or more types of routes.

In the part (A) in FIG. 11, the hatched region represents a section in which map data exists on the route. The total length of the section in which the map data exists on the route is hereinafter referred to as “map existence distance L_map”. The first map existence distance L1_map is a map existence distance L_map on the first route P1, and the second map existence distance L2_map is a map existence distance L_map on the second route P2. The first map existence distance L1_map is longer than the second map existence distance L2_map.

In the part (A) in FIG. 11, the map fullness is calculated based on the map existence distance L_map. For example, the map fullness is calculated to be proportional to the map existence distance L_map. Since the first map presence distance L1_map is longer than the second map presence distance L2_map, the map fullness of the first route P1 is higher than the map fullness of the second route P2. As another example, a “map presence rate (L_map/L_tot)”, which is a ratio of the map presence distance L_map to the total length L_tot of the route to the destination, may be used. In this case, the map fullness is calculated to be proportional to the map presence rate. For example, the map fullness of the first route P1 is higher than the map fullness of the second route P2 when the total length of the first route P1 is equal to the total length of the second route P2.

Note that the granularity of the route may be a road, a lane in the road, or a position in the lane. For example, as indicated by part (B) in FIG. 11, the first route P1 and the second route P2 may be different lanes in the same road.

Further, as indicated by the part (B) in FIG. 11, the map data is not necessarily present at all the horizontal positions in the width direction (horizontal direction) of the road or the lane. There is a possibility that a horizontal position in which map data is present and a horizontal position in which map data is not present are mixed. Therefore, when the granularity of the route is a road or a lane, the map existence distance L_map may be calculated as follows, for example. First, a distribution of the presence or absence of map data in the lateral direction is acquired for each unit distance along the route. A coefficient “1” is assigned to the horizontal position (unit area M) in which the map data is present, and a coefficient “0” is assigned to the horizontal position (unit area M) in which the map data is not present. Subsequently, the average value of the coefficients in the lateral direction is calculated as a correction coefficient (weight) related to the unit distance. Then, a product of the unit distance and the correction coefficient (weight) integrated along the route is calculated as the map existence distance L_map.

In the part (C) in FIG. 11, the above-described number of travels N is taken into consideration. The map data (unsprung displacement Zu) of a certain position is calculated from the information for updating the map N times including the information for updating the most recent map. It can be said that the number of traveling times N indicates how much map data is calculated based on the map update information. As the number of travels N increases, the accuracy of the map data increases. Therefore, an increase in the number of travels N also contributes to an improvement in the map fullness. The number of runs N at each position (unit area M) is obtained from the unsprung displacement map 200 as shown in FIG. 7. Then, the map fullness is calculated so as to be proportional to the sum or average value of the number of travels N along the route. In the embodiment illustrated in the part (C) in FIG. 11, the number of travels N along the first route P1 is generally large, and the number of travels N along the second route P2 is generally small. Therefore, the map fullness of the first route P1 is higher than the map fullness of the second route P2. The correction coefficient (weight) in consideration of the distribution of the presence or absence of the map data in the lateral direction is also applicable to the number of travels N.

In the part (D) in FIG. 11, a different unsprung displacement map 200 is generated for each vehicle speed range. With respect to the first route P1, all the unsprung displacement maps 200 for high speed, medium speed, and low speed are already present. On the other hand, with respect to the second route P2, only the unsprung displacement map 200 for the low speed exists, and the unsprung displacement map 200 for the other vehicle speed range does not exist. Again, it can be said that the map fullness of the first route P1 is higher than the map fullness of the second route P2.

Combinations of the above aspects are also possible. That is, the map fullness may be calculated based on a combination of two or more viewpoints among the part (A), the part (C), and the part (D) in FIG. 11. For example, the evaluation value (score) is calculated by inputting the map existence distance L_map and the number of travels N into a predetermined evaluation formula. Then, the higher the evaluation value (score), the higher the map fullness is calculated. As another example, the final map fullness may be calculated by combining two or more map fullness degrees calculated based on two or more viewpoints.

### 5-2. Improvement of Map Fullness

Improving the map fullness of the unsprung displacement map 200 is preferable from the viewpoint of vehicle control using the unsprung displacement map 200. Therefore, the present embodiment proposes a technique capable of promoting an improvement in the map fullness of the unsprung displacement map 200.

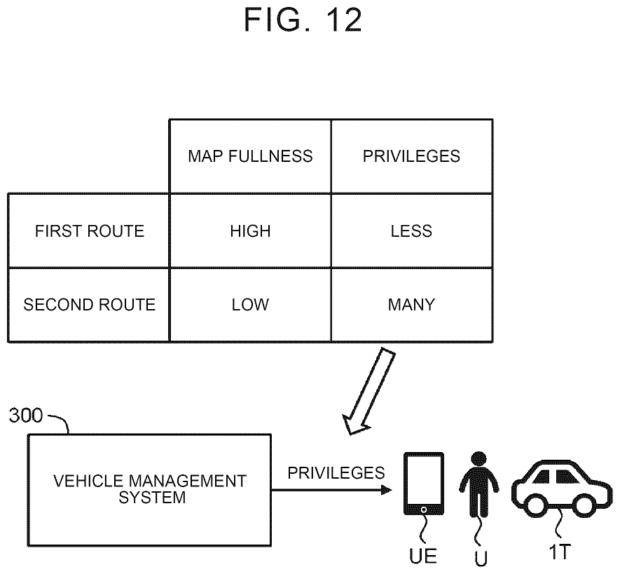

FIG. 12 is a conceptual diagram for explaining an outline of the vehicle management system 300 according to the present embodiment. The vehicle management system 300 can cooperate with the vehicle control system 10 and the map management system 100. The vehicle management system 300 can communicate with the vehicle control system 10 and the map management system 100. The vehicle management system 300 may be included in the vehicle control system 10 or may be partially common to the vehicle control system 10. The vehicle management system 300 may be included in the map management system 100 or may be partially common to the map management system 100. The vehicle management system 300 may be distributed between the vehicle control system 10 and the map management system 100.

The target vehicle 1T is a target of vehicle control by the vehicle control system 10. The vehicle management system 300 is configured to, in cooperation with the vehicle control system 10, give a “privilege” to the user U of the target vehicle 1T satisfying the requirement. Examples of the privilege include a discount of a service usage fee, a point grant, a coupon provision, and the like. For example, when the target vehicle 1T provides a mobility service such as a MaaS or a taxi, the benefit is a discount on the usage fee of the mobility service. As another example, if the unsprung displacement map 200 is paid, the benefit is a discount on the usage fee of the unsprung displacement map 200. The vehicle management system 300 may provide the user terminal UE with a privilege given to the user U.

The vehicle management system 300 holds an unsprung displacement map 200. The vehicle management system 300 calculates the present map fullness of the route to the destination of the target vehicle 1T on the basis of the unsprung displacement map 200. The method of calculating the map fullness of the route is as described in Section 5-1 above.

Further, the vehicle management system 300 sets a privilege according to the map fullness of the route. It is assumed that there are a first route P1 and a second route P2 as route candidates to the destination, and the map fullness of the first route P1 is higher than the map fullness of the second route P2. In this case, the vehicle management system 300 sets the privilege when the target vehicle 1T travels in the second route P2 to be larger than the privilege when the target vehicle 1T travels in the first route P1. Accordingly, the user U of the target vehicle 1T is given an incentive to select the second route P2 having the lower map fullness. As a consequence, it is expected that the target vehicle 1T will be more likely to travel on the second route P2 having a lower map fullness. The vehicle management system 300 provides the user U with a privilege corresponding to the route actually traveled by the target vehicle 1T.

When the target vehicle 1T travels on at least the second route P2, the vehicle management system 300 cooperates with the vehicle control system 10 to collect map updating data along the second route P2. As described above, the map updating information is information for calculating the unsprung displacement Zu (vertical motion parameter). The map updating information collected by the target vehicle 1T is sent to the map management system 100. The map management system 100 updates the map data of the unsprung displacement map 200 along the second route P2 based on the new map updating information. This improves the map fullness along the second route P2.

The map fullness changes between before and after the target vehicle 1T travels in the second route P2. The vehicle management system 300 may acquire the “map expansion degree”. The map enhancement degree is proportional to the increased amount of the map enhancement degree between before and after the target vehicle 1T travels in the second route P2. The map enhancement degree may be calculated after the target vehicle 1T travels in the second route P2, or may be estimated prior to the target vehicle 1T travels in the second route P2. Then, the vehicle management system 300 may set a privilege when the target vehicle 1T travels in the second route P2 in accordance with the map expansion degree. More specifically, the vehicle management system 300 may set the privilege larger as the map expansion degree increases. Thereby, the amount of the privilege is further optimized.

As described above, when the target vehicle 1T travels in the second route P2 in which the map enhancement degree of the unsprung displacement map 200 is low, more privileges are given to the user U of the target vehicle 1T. In other words, the user U of the target vehicle 1T is given an incentive to select a second route P2 having a lower map fullness. This is expected to increase the chance that the target vehicle 1T travels in the second route P2 having a lower map fullness. When the target vehicle 1T travels in the second route P2, the map updating information along the second route P2 is newly obtained. Consequently, the map fullness along the second route P2 is improved. As described above, according to the present embodiment, it is possible to promote the improvement of the map fullness. Improvement of the map fullness is preferable from the viewpoint of vehicle control such as preview control using the unsprung displacement map 200.

### 5-3. Configuration Example of Vehicle Management System

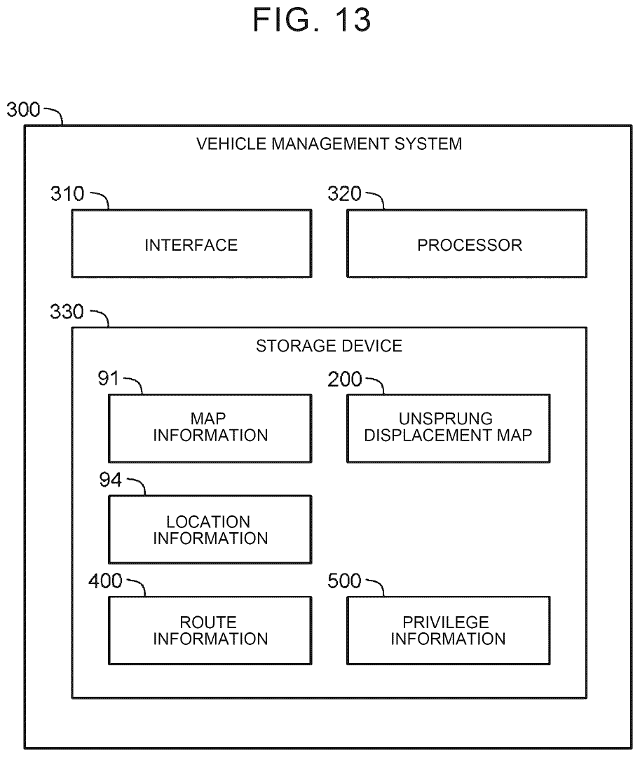

FIG. 13 is a block diagram illustrating a configuration example of the vehicle management system 300 according to the present embodiment. The vehicle management system 300 includes one or more interfaces 310, one or more processors 320, and one or more storage devices 330.

The interface 310 includes a communication interface. The vehicle management system 300 can communicate with the vehicle control system 10 and the map management system 100 via a communication interface. The interface 310 may also include a user interface that provides information to and accepts input from the user U. Examples of the user interface include a touch panel, a display, and the like. The user interface may be a navigation system mounted on the target vehicle 1T. The user interface may be a user terminal UE.

The processor 320 executes various types of information processing. Examples of the processor 320 include CPU, ASIC, FPGA, and the like. The processor 320 may also be referred to as processing circuitry. The processor 320 may be the same as the processor 71 of the vehicle control system 10. The processor 320 may be the same as the processor 120 of the map management system 100.

The storage device 330 stores various types of information. Examples of the storage device 330 include a volatile memory, a nonvolatile memory, and an HDD, SSD.

The storage device 330 may be the same as the storage device 72 of the vehicle control system 10. The storage device 330 may be the same as the storage device 130 of the map management system 100. The storage device 330 stores an unsprung displacement map 200. The unsprung displacement map 200 is obtained from the map management system 100. The storage device 330 stores map information 91 and position information 94. The position information 94 is information indicating the position of the target vehicle 1T, and is obtained from the vehicle control system 10.

The processor 320 may execute a computer program. The computer program is stored in the storage device 330. Alternatively, the computer program may be recorded on a computer-readable recording medium. The processor 320 may execute a computer program to implement the functions of the vehicle management system 300.

The processor 320 acquires the destination of the target vehicle 1T. The method of setting the destination is arbitrary. For example, the processor 320 receives destination information from the user U via the interface 310. The processor 320 calculates one or more route candidates from the present position of the target vehicle 1T to the destination based on the destination, the map information 91, and the position information 94. A method of calculating a route candidate is well known in the art, and is not particularly limited. Route candidates with too long a distance or with too long a required time may be excluded in advance. The degree of consideration of the distance and the required time may be appropriately set by the user U. The route information 400 indicates the calculated route candidate. The route information 400 is stored in the storage device 330.

The processor 320 calculates the current map fullness of each route candidate based on the route information 400 and the unsprung displacement map 200. The method of calculating the map fullness is as described in Section 5-1 above. Further, the processor 320 sets a privilege according to the map fullness of the route. It is assumed that there are a first route P1 and a second route P2 as route candidates to the destination, and the map fullness of the first route P1 is higher than the map fullness of the second route P2. In this case, the processor 320 sets the privilege when the target vehicle 1T travels in the second route P2 to be larger than the privilege when the target vehicle 1T travels in the first route P1.

The privilege information 500 indicates the content of the privilege set for each route candidate. The privilege information 500 is stored in the storage device 330. The processor 320 may present the privilege information 500 to the user U via the interface 310. The processor 320 gives the user U a privilege corresponding to the route actually traveled by the target vehicle 1T. For example, the processor 320 provides the user terminal UE with the privilege given to the user U.

When the target vehicle 1T travels in at least the second route P2, the processor 320 cooperates with the vehicle control system 10 to collect map updating data along the second route P2. This improves the map fullness along the second route P2.

The processor 320 may obtain a map enhancement degree. The map enhancement degree is proportional to the increased amount of the map enhancement degree between before and after the target vehicle 1T travels in the second route P2. The map enhancement degree may be calculated after the target vehicle 1T travels in the second route P2, or may be estimated prior to the target vehicle 1T travels in the second route P2. Then, the processor 320 may set a privilege when the target vehicle 1T travels in the second route P2 in accordance with the map enhancement degree. More specifically, the processor 320 may set the privilege larger as the map expansion degree increases. Thereby, the amount of the privilege is further optimized.

### 5-4. User Presentation Function

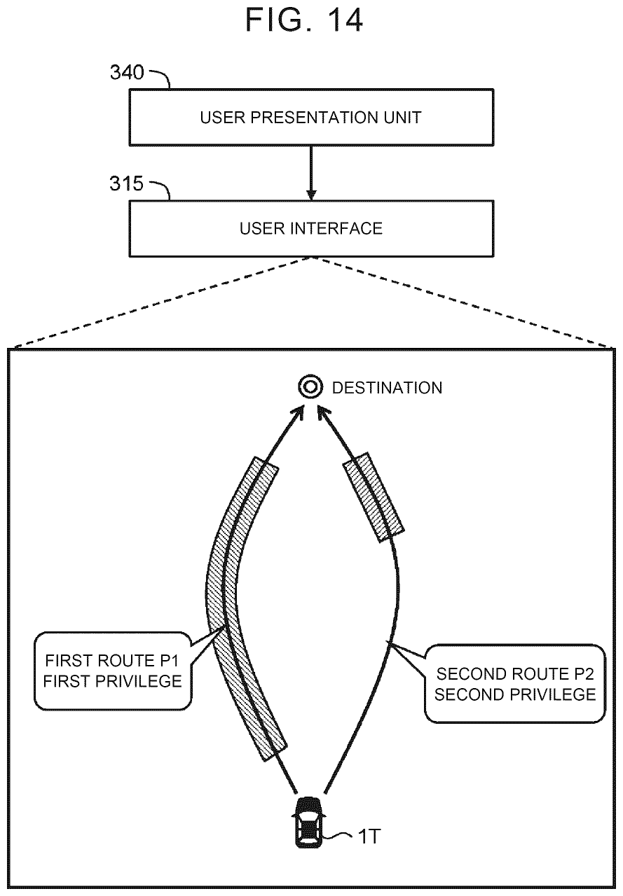

FIG. 14 is a conceptual diagram for describing a user presentation function of the vehicle management system 300. The vehicle management system 300 (processor 320) includes a user presentation unit 340. The interface 310 includes a user interface 315. For example, the user interface 315 is a navigation system mounted on the target vehicle 1T. Alternatively, the user interface 315 may be a user terminal UE.

The user presentation unit 340 presents the route information 400 and the privilege information 500 to the user U of the target vehicle 1T via the user interface 315. For example, as shown in FIG. 14, the first privilege given in the case of the first route P1 and the first route P1 and the second privilege given in the case of the second route P2 and the second route P2 are presented. The user U can consider whether to select the first route P1 or the second route P2 by looking at the presented data.

The user U designates a desired route using the user interface 315. For example, the navigation system starts navigation based on a route designated by the user U. The user U drives the target vehicle 1T according to the designated route. Alternatively, when the target vehicle 1T is an autonomous vehicle, the target vehicle 1T automatically travels according to a route designated by the user U. In both cases, a privilege corresponding to the route on which the target vehicle 1T actually travels is given to the user U.

### 5-5. Routing Function

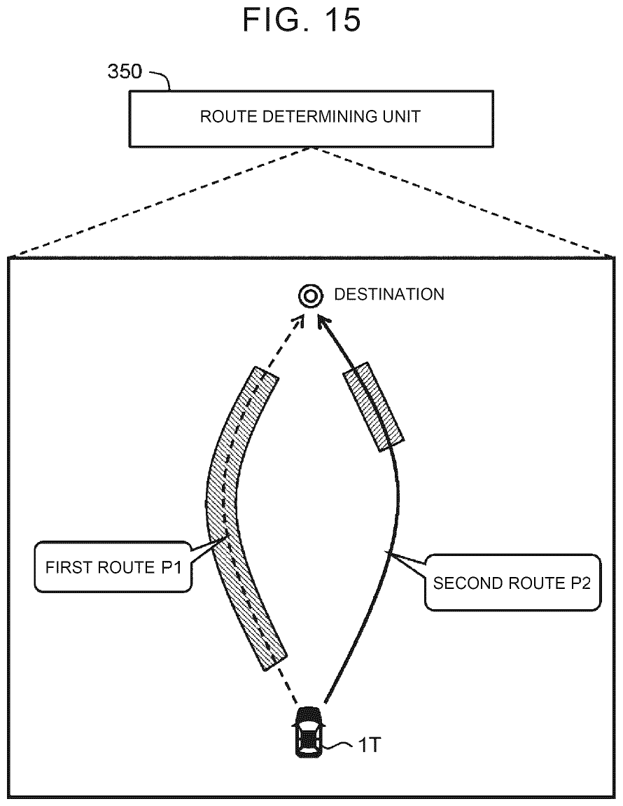

FIG. 15 is a conceptual diagram for describing a route determination function of the vehicle management system 300. The vehicle management system 300 (processor 320) includes a route determination unit 350. The route determination unit 350 automatically determines the travel route of the target vehicle 1T based on the route information 400 and the map fullness in accordance with a predetermined policy. For example, it is assumed that there are a first route P1 and a second route P2 as route candidates to the destination, and the map fullness of the first route P1 is higher than the map fullness of the second route P2. In this case, the route determination unit 350 may preferentially determine the second route P2 as the travel route of the target vehicle 1T over the first route P1. As a result, the user U can obtain many privileges, and the map fullness along the second route P2 is improved.

### 5-6. Mode Switching Function

A plurality of modes may be provided for determining the travel route of the target vehicle 1T. For example, the plurality of modes includes a comfort-oriented mode (first mode) and a privilege-oriented mode (second mode). The comfort-oriented mode is a mode in which preview control using the unsprung displacement map 200 is actively used. On the other hand, the privilege-oriented mode is a mode in which it is important to acquire more privileges. That is, the privilege-oriented mode prioritizes the privilege over the comfort-oriented mode. The user of the target vehicle 1T can select his or her preferred mode.

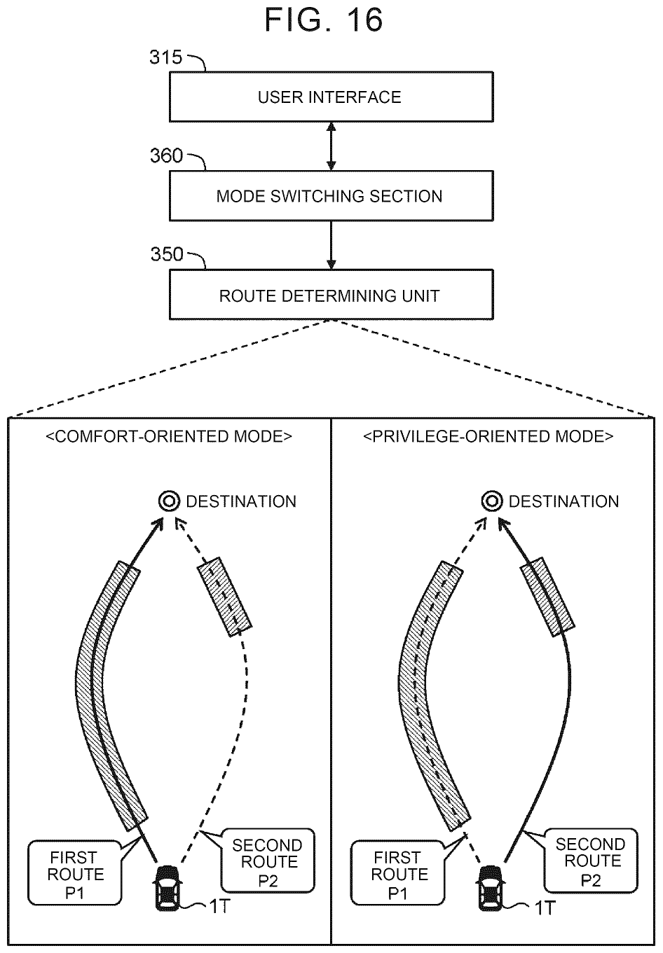

FIG. 16 is a conceptual diagram for describing the mode switching function of the vehicle management system 300. The vehicle management system 300 (processor 320) includes a route determination unit 350 and a mode switching unit 360. The interface 310 includes a user interface 315.

The mode switching unit 360 presents a plurality of modes to the user U through the user interface 315. The user U selects a preferred mode through the user interface 315. The mode switching unit 360 receives a mode selection result by the user U through the user interface 315.

When the comfort-oriented mode is selected, the mode switching unit 360 operates the route determination unit 350 in the comfort-oriented mode. In the comfort-oriented mode, the route determination unit 350 determines the first route P1 as the travel route of the target vehicle 1T preferentially over the second route P2. Since the target vehicle 1T travels in the first route P1 having a higher degree of map fullness, preview control using the unsprung displacement map 200 can be performed sufficiently and effectively. As a result, comfort and satisfaction of the user U are improved.

On the other hand, when the privilege-oriented mode is selected, the mode switching unit 360 operates the route determination unit 350 in the privilege-oriented mode. In the privilege-oriented mode, the route determination unit 350 preferentially determines the second route P2 as the travel route of the target vehicle 1T rather than the first route P1. As a consequence, the user U can obtain more privileges, and the map fullness along the second route P2 is improved.

Multiple modes may be further subdivided. In generalization, the plurality of modes includes a first mode and a second mode that prioritizes a privilege over the first mode. In the first mode, the route determination unit 350 preferentially determines the first route P1 as the travel route of the target vehicle 1T rather than the second route P2. As a result, comfort and satisfaction of the user U are improved. On the other hand, in the second mode, the route determination unit 350 preferentially determines the second route P2 as the travel route of the target vehicle 1T rather than the first route P1. As a consequence, the user U can obtain more privileges, and the map fullness along the second route P2 is improved.

What is claimed is:

1. A vehicle management system comprising:
one or more storage devices, the storage devices being configured to store a map indicating a correspondence relationship between a position and a vertical motion parameter associated with vertical motion of a wheel of a vehicle; and
one or more processors, the processors being configured to give a privilege to a user of a target vehicle, wherein:
a route to a destination of the target vehicle includes a first route and a second route having a degree of fullness of the map that is lower than the first route; and
the one or more processors are configured to
set the privilege to be given when the target vehicle travels through the second route to be greater than the privilege to be given when the target vehicle travels through the first route, and
cause the target vehicle to collect information for updating the map along the second route when the target vehicle travels through the second route.

2. The vehicle management system according to claim 1, wherein the one or more processors are further configured to:
acquire a map enhancement degree that is proportional to an amount of increase in the degree of fullness of the map between before and after the target vehicle travels through the second route; and
set the privilege to be given when the target vehicle travels through the second route according to the map enhancement degree.

3. The vehicle management system according to claim 1, wherein the one or more processors are further configured to present the first route, the second route, and the privilege to the user.

4. The vehicle management system according to claim 1, wherein the one or more processors are further configured to determine the second route as a travel route of the target vehicle in priority to the first route.

5. The vehicle management system according to claim 1, wherein:
the target vehicle is configured to execute preview control for suppressing vibration of the target vehicle based on the vertical motion parameter obtained from the map;
a plurality of modes includes a first mode and a second mode in which priority is given to the privilege over the first mode; and
the one or more processors are further configured to
determine the first route as a travel route of the target vehicle in priority to the second route in the first mode, and
determine the second route as a travel route of the target vehicle in priority to the first route in the second mode.
